(19) United States
(12) Patent Application Publication
(10) Pub. No.: US 2025/0073634 A1
(43) Pub. Date: Mar. 6, 2025

(54) CARBON DIOXIDE SEPARATION DEVICE

(71) Applicants: thyssenkrupp Industrial Solutions AG, Essen (DE); thyssenkrupp AG, Essen (DE)

(72) Inventor: Johannes MENZEL, Waltrop (DE)

(73) Assignees: Thyssenkrupp Industrial Solutions AG, Essen (DE); thyssenkrupp AG, Essen (DE)

(21) Appl. No.: 18/722,135

(22) PCT Filed: Dec. 15, 2022
(86) PCT No.: PCT/EP2022/086195

§ 371 Date: Jun. 20, 2024

(30) Foreign Application Priority Data
Dec. 21, 2021 (BE) BE 2021/6009
Dec. 21, 2021 (DE) 10 2021 214 786.0

(51) Int. Cl. B01D 53/14

(52) U.S. Cl. CPC B01D 53/1475; B01D 53/1418; B01D 2257/504

(57) ABSTRACT

A carbon dioxide separation apparatus comprises an absorption apparatus and a desorption apparatus, wherein the absorption apparatus comprises a gas inlet for the gas to be purified and a gas outlet for the purified gas, wherein the absorption apparatus comprises an absorption solvent inlet and a solution outlet, wherein the desorption apparatus comprises at least one first solution inlet, an absorption solvent outlet, a hot solvent inlet and a carbon dioxide outlet, wherein the solution outlet is connected to the first solution inlet via a first solution conduit, wherein the first solution conduit comprises a first heat exchanger, wherein the absorption solvent outlet is connected to the absorption solvent inlet via an absorption solvent conduit, wherein the absorption solvent conduit comprises the first heat exchanger so that the heat of the solvent stream is transferred to the solution stream, wherein the absorption solvent conduit comprises a branch to a hot solvent conduit, wherein the hot solvent conduit is connected to the hot solvent inlet, wherein the hot solvent conduit comprises a second heat exchanger, and wherein the pressure of the solvent in the second heat exchanger is 0.2 bar to 5 bar higher than the pressure in the desorption apparatus at the absorption solvent outlet.

The invention relates to an apparatus for separating carbon dioxide from gases, in particular from offgases.

In order to reduce man-made climate change, emission of carbon dioxide into the atmosphere is increasingly being avoided. Instead, attempts are made to separate carbon dioxide formed and then either convert it or send it for storage. A typical process to this end comprises scrubbing offgases with a basic solution, for example an amine solution, at about 25° C. to 50° C. This amine solution acts as a solvent in which the carbon dioxide dissolves. The solution containing the carbon dioxide is then heated and in a desorption step the carbon dioxide is converted back into the gas phase. This restores the solvent and also affords a pure carbon dioxide gas stream. The carbon dioxide gas stream may then, for example and purely exemplarily, be sent for storage or supplied to a methanol synthesis.

WO 2010/086 039 A1 discloses a process and an apparatus for separating carbon dioxide from an offgas of a fossil-fired power plant.

CN 111203086 A discloses a CO₂ separation system with low energy consumption and low emissions.

WO 2014/077 919 A1 discloses an apparatus and a process for removing acidic gases from a gas stream and regeneration of the absorbent solution.

US 2017/0197175 A1 discloses an energy-efficient process for extracting acidic gases from a gas stream.

WO 2013/013 749 A1 discloses thermal recovery in absorption and desorption processes.

WO 2019/232 626 A1 discloses a CO₂ separation after combustion with thermal recovery.

All plants for separating CO₂ have in common that energy must be supplied for re-emission of the CO₂ from the solution. To this end, heat at a high and thus comparatively valuable level is employed.

It is an object of the invention to provide a carbon dioxide separation apparatus where the overall process of absorption and desorption is energetically optimized.

This object is achieved by the carbon dioxide separation apparatus having the features specified in claim 1. Advantageous developments are apparent from the dependent claims, the following description and the drawings.

The carbon dioxide separation apparatus according to the invention comprises an absorption apparatus and a desorption apparatus. In the absorption apparatus the gas to be purified of carbon dioxide is introduced and the carbon dioxide from the gas phase transferred into the liquid phase through contact with a solvent, usually an amine solution. This forms a solution of the solvent with the carbon dioxide dissolved and optionally bound therein. This solution is transferred into the desorption apparatus where the carbon dioxide is re-expelled from the solution so that the solvent is recovered and recycled into the absorption apparatus. A carbon dioxide gas stream which may be sent for further use is likewise obtained. This basic principle is already used in numerous variations.

The absorption apparatus has a gas inlet for the gas to be purified and a gas outlet for the purified gas. The gas to be purified may be an offgas from the combustion of fossil fuels for example. The purified gas would then be mainly nitrogen with a small remainder of carbon dioxide and optionally a proportion of oxygen which is markedly reduced by the combustion process. The purified gas may then be emitted to the atmosphere for example without releasing large amounts of the greenhouse gas carbon dioxide. The absorption apparatus typically comprises one or more mass transfer elements arranged between the gas inlet and the absorption solvent inlet. The mass transfer elements serve to better contact the liquid phase and the gaseous phase, in particular also to increase the surface area of the liquid phase. Such mass transfer elements are known to those skilled in the art and may be for example bubble cap trays, random packings or a structured packing.

The absorption apparatus further comprises an absorption solvent inlet and a solution outlet. The absorption solvent inlet is typically arranged at the top of the absorption apparatus and the solution outlet at the bottom of the absorption apparatus. Accordingly the gas inlet is typically arranged at the bottom and the gas outlet at the top so that gas and solvent flow through the absorption apparatus in countercurrent.

The desorption apparatus comprises at least a first solution inlet, an absorption solvent outlet, a hot solvent inlet and a carbon dioxide outlet. The solution outlet of the absorption apparatus is connected to the first solution inlet of the desorption apparatus via a first solution conduit. The first solution conduit comprises a first heat exchanger. This heats the solvent stream flowing through the first solution conduit so that the carbon dioxide present in the solution can be re-emitted in the desorption apparatus. The absorption solvent outlet of the desorption apparatus is connected to the absorption solvent inlet of the absorption apparatus via an absorption solvent conduit. The solvent depleted of carbon dioxide in the desorption apparatus flows back to the absorption apparatus via the absorption solvent conduit. The absorption solvent conduit likewise comprises the first heat exchanger. This transfers the heat of the solvent stream in the absorption solvent conduit to the solution stream. The absorption solvent conduit comprises a branch to a hot solvent conduit. A substream of the solvent stream is thus diverted and passed into the hot solvent conduit. The hot solvent conduit is connected to the hot solvent inlet. The hot solvent conduit comprises a second heat exchanger. This allows additional energy to be introduced into the overall system. The desorption apparatus typically comprises one or more mass transfer elements arranged above and below the first solution inlet. The mass transfer elements serve to better contact the liquid phase and the gaseous phase, in particular also to increase the surface area of the liquid phase. Such mass transfer elements are known to those skilled in the art and may be for example bubble cap trays or random packings.

According to the invention the pressure of the solvent in the second heat exchanger is 0.2 bar to 5 bar higher than the pressure in the desorption apparatus at the absorption solvent outlet. A higher starting temperature can thus be achieved in the second heat exchanger since the elevated pressure increases the boiling point. This in turn has the result that the solvent has a higher temperature at the absorption solvent outlet and thus passes into the first heat exchanger at a higher temperature. This makes it possible for said exchanger to be made more compact or to attain a higher starting temperature for the laden solution stream from the first heat exchanger. The latter in turn leads to more efficient stripping of the carbon dioxide from the solution.

The pressure of the solvent in the second heat exchanger is adjustable within apparatus limits. There are two exemplary and preferred embodiments of specific adjustment of the pressure via the apparatus. In a first exemplary and preferred embodiment of the invention the pressure of the solvent in the second heat exchanger is 0.2 bar to 5 bar higher than the pressure in the desorption apparatus at the absorption solvent outlet because the second heat exchanger is arranged at least 1 m in height below the absorption solvent outlet so that the pressure in the second heat exchanger is increased by the hydrostatic column of the solvent corresponding to the total height difference. In a second exemplary and preferred embodiment of the invention the pressure of the solvent in the second heat exchanger is 0.2 bar to 5 bar higher than the pressure in the desorption apparatus at the absorption solvent outlet because a first pump for producing the corresponding positive pressure is arranged upstream of the second heat exchanger.

In a further embodiment of the invention a pressure reduction means, for example a control valve, an aperture plate or a pipe narrowing, is arranged between the second heat exchanger and the desorption apparatus. The pressure reduction means establishes/maintains the desired positive pressure in the second heat exchanger on the gas/vapor side. This can prevent evaporation in the second heat exchanger if necessary.

It is preferable when the first solution inlet is arranged in the middle region of the desorption apparatus.

In a further embodiment of the invention the first solution conduit comprises an evaporation apparatus downstream of the first heat exchanger. The evaporation apparatus, also known as a decompression vessel, ensures that the solution of the solution stream heated in the first heat exchanger can undergo decompression and partially evaporate. The liquid phase of the solution stream is thus separated from the gaseous phase of the solution stream in the evaporation apparatus. The liquid phase is passed into the desorption apparatus via the first solution conduit. Application of the liquid phase via the first solution conduit and the first solution inlet is preferably effected between two mass transfer elements. The desorption apparatus further comprises a vapor inlet and the evaporation apparatus comprises a vapor outlet. The vapor outlet of the evaporation apparatus and the vapor inlet of the desorption apparatus are connected to a gas solution conduit for transfer of the gaseous phase. It is particularly preferable when the vapor inlet is arranged in the lower region of the desorption apparatus. It is preferable when no mass transfer elements are arranged in the lower region. This optimizes the energetic management of the entire process.

In a further embodiment of the invention, a second solution conduit branches off from the first solution conduit between the absorption apparatus and the first heat exchanger. The second solution conduit leads directly into the top of the desorption apparatus. In this context directly is to be understood as meaning without a heat exchanger or the like. A (flow control) valve may optionally be arranged here. Thus the carbon dioxide-laden solution is itself used to cool the gas stream emerging from the desorption apparatus. This has the result that the heat supplied from the first heat exchanger and the second heat exchanger and that supplied to the desorption means remains in the desorption means and in the solvent and is not emitted to a cooling medium.

The carbon dioxide separation apparatus according to the invention is more particularly elucidated hereinbelow with reference to a exemplary embodiment shown in the drawings.

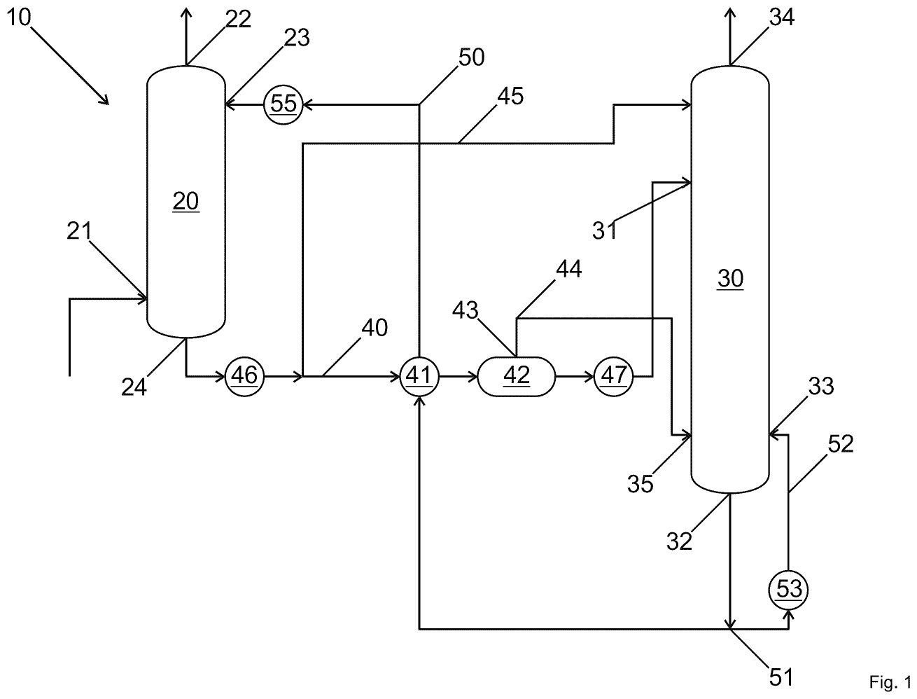

FIG. 1 First exemplary embodiment

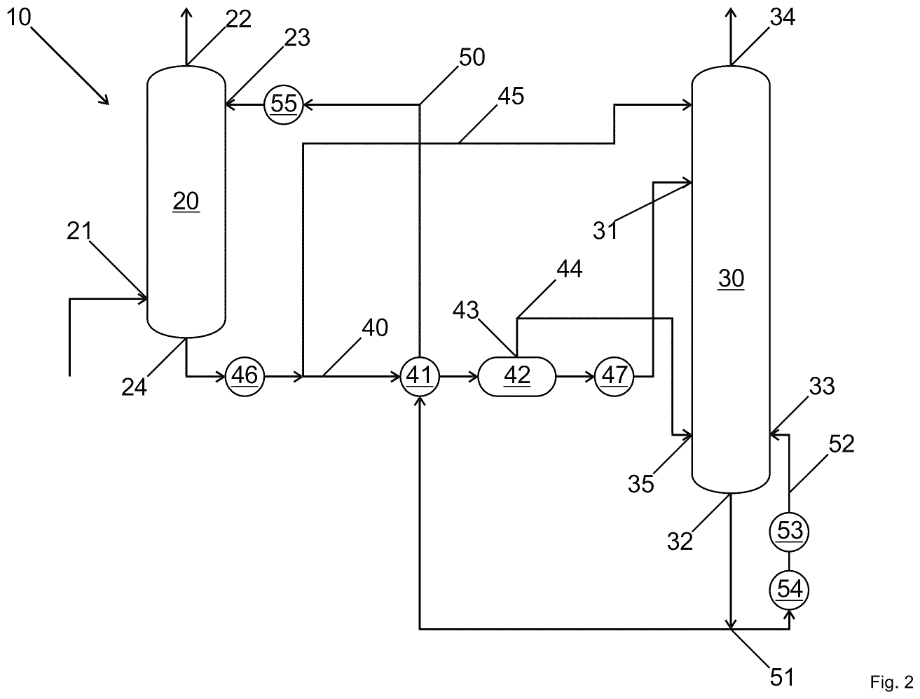

FIG. 2 Second exemplary embodiment

The illustrations shown are purely schematic and serve to illustrate the invention. The same parts of the different exemplary embodiments are given the same numbers for the sake of simplicity. 10

FIG. 1 shows a first exemplary embodiment of an inventive carbon dioxide separation apparatus 10. The carbon dioxide separation apparatus 10 is used for example to separate the carbon dioxide from an offgas stream which enters the gas inlet 21 and exits again heavily depleted in carbon dioxide at the gas outlet 22. In the absorption apparatus 20 this gas stream is contacted in countercurrent with a solvent, usually an amine solution, to bring the carbon dioxide into solution. This solution exits the absorption apparatus at the solution outlet 24 and is pumped through the first solution conduit 40 via a second pump 46. The first solution conduit 40 comprises a first heat exchanger 41 in which the solution stream is heated by the solvent stream from the absorption solvent conduit 50. An evaporation apparatus 42 in which the solution can be partially converted into the gas phase is arranged downstream of the first heat exchanger 41. The liquid phase of the solution stream is conveyed further through the first solution conduit 40, for example conveyed through the first solution inlet 31 into the desorption apparatus 30 by means of a third pump 47. The gas/vapors formed in the evaporation apparatus 42 is/are passed through the vapor outlet 43 into the gas solution conduit 44 and through said conduit via the vapor inlet 35 into the desorption apparatus 30. The vapor inlet 35 is preferably located at the lower end, i.e. the bottom, of the desorption apparatus 30.

In the desorption apparatus 30 the carbon dioxide is thermally removed from the solution and discharged via the carbon dioxide outlet 34. This carbon dioxide stream may then be supplied for example to a further reaction or to storage. The solvent freed of carbon dioxide collects on the bottom of the desorption apparatus 30 and is supplied through the absorption outlet 32 to the absorption conduit 50. The solvent stream gives its thermal energy to the solution stream in the first heat exchanger 41. For example a fourth pump is used to pass the solvent stream via a third heat exchanger 55 through the absorption solvent inlet 23 into the absorption apparatus.

A substream is diverted from the solvent stream in the absorption solvent conduit 50 at the branch 51 and is conveyed through the hot solvent conduit 52 via the second heat exchanger 53 in particular in vaporous form or as a vapor/liquid mixture through the hot solvent inlet 33 back into the desorption apparatus 30. The required energy for stripping the carbon dioxide from the solution is supplied to the system via the second heat exchanger 53. The second heat exchanger 53 is arranged for example 3.5 m below the absorption solvent outlet 32 so that the water column establishes an overpressure of about 0.35 bar. This allows the second heat exchanger 53 to heat the solvent substream to a higher temperature which in turn has the result that the entry temperature of the solvent stream passed through the absorption solvent conduit 50 is also correspondingly elevated upstream of the first heat exchanger 41.

The second exemplary embodiment shown in FIG. 2 differs from the first exemplary embodiment shown in FIG. 1 in that the pressure in the second heat exchanger 53 is achieved not by a height difference which reduces design height but rather by a first pump 54.

### LIST OF REFERENCE NUMERALS

10 Carbon dioxide separation apparatus
20 Absorption apparatus
21 Gas inlet
22 Gas outlet
23 Absorption solvent inlet
24 Solution outlet
30 Desorption apparatus
31 First solution inlet
32 Absorption solvent outlet
33 Hot solvent inlet
34 Carbon dioxide outlet
35 Vapor inlet
40 First solution conduit
41 First heat exchanger
42 Evaporation apparatus
43 Vapor outlet
44 Gas solution conduit
45 Second solution conduit
46 Second pump
47 Third pump
50 Absorption solvent conduit
51 Branch
52 Hot solvent conduit
53 Second heat exchanger
54 First pump
55 Third heat exchanger

1-6. (canceled)

7. A carbon dioxide separation apparatus, comprising:
an absorption apparatus; and
a desorption apparatus;
wherein the absorption apparatus includes a gas inlet for the gas to be purified and a gas outlet for the purified gas;
wherein the absorption apparatus includes an absorption solvent inlet and a solution outlet;
wherein the desorption apparatus includes a first solution inlet, an absorption solvent outlet, a hot solvent inlet and a carbon dioxide outlet;
wherein the solution outlet is connected to the first solution inlet via a first solution conduit;
wherein the first solution conduit includes a first heat exchanger;
wherein the absorption solvent outlet is connected to the absorption solvent inlet via an absorption solvent conduit;
wherein the absorption solvent conduit includes the first heat exchanger so that the first heat exchanger is configured to transfer heat from the absorption solvent conduit to the first solution conduit;
wherein the absorption solvent conduit includes a branch to a hot solvent conduit;
wherein the hot solvent conduit is connected to the hot solvent inlet;
wherein the hot solvent conduit includes a second heat exchanger;
wherein a pressure of a solvent in the second heat exchanger is 0.2 bar to 5 bar higher than a pressure in the desorption apparatus at the absorption solvent outlet.

8. The carbon dioxide separation apparatus as claimed in claim 7, wherein the pressure of the solvent in the second heat exchanger is 0.2 bar to 5 bar higher than the pressure in the desorption apparatus at the absorption solvent outlet because the second heat exchanger is arranged at least 1 meter below the absorption solvent outlet so that the pressure is produced by the hydrostatic pressure of the solvent.

9. The carbon dioxide separation apparatus as claimed in claim 7, wherein the pressure of the solvent in the second heat exchanger is 0.2 bar to 5 bar higher than the pressure in the desorption apparatus at the absorption solvent outlet because a pump for producing positive pressure is arranged upstream of the second heat exchanger.

10. The carbon dioxide separation apparatus as claimed in claim 7, wherein the first solution conduit includes an evaporation apparatus arranged downstream of the first heat exchanger, wherein the evaporation apparatus separates a liquid phase within the first solution conduit from a gaseous phase within the first solution conduit, wherein the liquid phase is passed through the first solution conduit into the desorption apparatus, wherein the desorption apparatus includes a vapor inlet, wherein the evaporation apparatus includes a vapor outlet, wherein the vapor outlet and the vapor inlet are connected to a gas solution conduit for transfer of the gaseous phase.

11. The carbon dioxide separation apparatus as claimed in claim 10, wherein the vapor inlet is arranged in the lower region of the desorption apparatus.

12. The carbon dioxide separation apparatus as claimed in claim 7, wherein a second solution conduit branches off from the first solution conduit between the absorption apparatus and the first heat exchanger, wherein the second solution conduit leads directly into the top of the desorption apparatus.
